(19) United States
(12) Patent Application Publication
(10) Pub. No.: US 2016/0165068 A1
(43) Pub. Date: Jun. 9, 2016

(54) Overload Processing For An Offline Charging System

(71) Applicant: Alcatel-Lucent USA Inc., Murray Hill, NJ (US)

(72) Inventor: Ranjan Sharma, New Albany, OH (US)

(73) Assignee: Alcatel-Lucent USA Inc., Murray Hill, NJ (US)

(21) Appl. No.: 14/560,393

(22) Filed: Dec. 4, 2014

(51) Int. Cl. H04M 15/00

(52) U.S. Cl. CPC H04M 15/65; H04M 15/41

(57) ABSTRACT

Systems and methods are provided for overload processing in an offline charging system of a communications services provider. A distributor unit is configured to receive accounting messages from a Charging Trigger Function (CTF) and determine that a destination Charging Data Function (CDF) intended for receiving the messages is in an overloaded state. Messages that are for ongoing sessions are transmitted to a selected destination queue of the overloaded destination CDF based on a designated queue status of the selected destination queue and while the destination CDF is in an overloaded state, while messages for new Diameter sessions are not sent to the selected destination queue of the overloaded destination CDF while the destination CDF remains in the overloaded state.

### TECHNICAL FIELD

The present disclosure is directed towards communication systems, and in particular, to charging functions in communication systems.

### BACKGROUND

Service providers typically provide numerous voice and data services to end users (also referred to as subscribers). Examples of voice services are voice calls, call forwarding, call waiting, etc. Examples of data services are messaging, streaming audio, streaming video, Voice over Internet Protocol (VoIP), online gaming, and IP-TV. The data services are managed by a packet core network, which interfaces the end user with external Packet Data Networks (PDN), such as the Internet. Some examples of packet core networks are a General Packet Radio Service (GPRS) core network, an Evolved Packet Core (EPC) of a Long Term Evolution (LTE) network, etc. Mobile devices, such as cell phones, personal data assistants, smart phones, notebook computers, etc., may access the data services provided by the networks over an air interface with one or more base stations.

The service providers use offline and online charging functions to keep track of the resource usage incurred by each device for using the various services. The 3GPP/3GPP2 standards groups have defined a set of specifications that may be used to implement online charging systems and offline charging systems in the various network domains (e.g., a circuit-switched domain, a packet-switched domain, and/or a wireless domain), IP multimedia subsystems, and emerging 3G/OMA application services.

According to 3GPP TS 32.240, offline charging is a process where charging information for network resource usage is collected concurrently with the resource usage. The charging information is passed through a chain of charging functions, which results in the generation of Charging Data Record (CDR) files that are transferred to the network operator's Billing Domain for subscriber billing and/or inter-operator accounting. To implement offline charging, a Charging Trigger Function (CTF) is implemented in a network element that provides a service. The CTF collects information pertaining to chargeable events, assembles this information into matching charging events, and sends the charging events to a Charging Data Function (CDF), which may be implemented in the network element or in the Offline Charging System (OFCS).

The CDF receives the charging events from one or more CTFs, and uses the information included in the charging events to construct CDRs. A CDR is a formatted collection of information about a chargeable event (e.g., time of call set-up, duration of the call, amount of data transferred, etc.) for use in billing and accounting. The CDF then sends the CDRs to a Charging Gateway Function (CGF) of the OFCS. The CGF acts as a gateway between the network and the billing domain. Therefore, the CGF collects CDRs from the CDF (and other CDFs), optionally correlates the CDRs and writes the CDRs into a CDR file, and makes the CDR file available to the billing domain.

A typical operator network will utilize multiple CDFs and CGFs to implement offline charging. Thus, a front-end device, such as a Diameter Routing Agent (DRA), is used in conjunction with (or as part of) the OFCS to distribute charging events from the CTFs to the CDFs. The front-end device typically uses a distribution algorithm to select a CDF for a particular session. For example, a distribution algorithm may process a session identifier from a Diameter ACR with a hashing function or another function to select a CDF. The front-end device then routes the Diameter ACR to the selected CDF.

### BRIEF SUMMARY

In various aspects, systems and methods for processing accounting messages in an offline charging system of a telecommunications services provider are provided. In one embodiment, a distributor unit connected to a plurality of Charging Data Functions (CDFs) of the offline charging system is configured to receive Diameter messages for one or more Diameter sessions from a Charging Trigger Function (CTF) associated with a Network Element (NE). The distributor unit is further configured to determine that a first destination queue of a first destination CDF that is selected for receiving the Diameter messages for the one or more Diameter sessions is designated in an overloaded state. For the Diameter messages that are for ongoing Diameter sessions, the distributor unit is further configured to continue to send the Diameter messages for the ongoing Diameter sessions to the first destination queue of the first destination CDF of the offline charging system while the first destination queue is designated in the overloaded state. For the Diameter messages that are for new Diameter sessions, the distributor unit is further configured to not send the Diameter messages for the new Diameter sessions to the first destination queue of the first CDF while the first destination queue is designated in the overloaded state.

In some embodiments, the distributor unit is configured to send the Diameter messages for the new Diameter sessions to a second destination queue of the a second destination CDF of the offline charging system based on the determination that the first destination queue of the first CDF is designated in the overloaded state.

In some embodiments, the distributor unit is configured to select the first destination queue of the first destination CDF and the second destination queue of the second destination CDF based on a parameter in the Diameter messages received from the CTF and a distribution algorithm. In some embodiments, the distribution algorithm is a consistent hashing algorithm that is applied for selecting the first destination queue or the second destination queue based on a session identifier in the Diameter messages.

In some embodiments, the distributor unit is configured to determine that a selected destination CDF for receiving Diameter messages for an ongoing Diameter session or a new Diameter session is out of service. In this case, the distributor unit is further configured to select an alternate destination CDF based on the distribution algorithm, insert an override parameter in the Diameter messages with a CDF identifier identifying the alternate destination CDF, and, send the Diameter messages to the alternate destination CDF.

In some embodiments, at least one of the Diameter messages received by the distributor unit is a Diameter Accounting Request (ACR).

In some embodiments, the distributor unit is configured to receive a recovery message from the first destination CDF indicating that the first destination queue has recovered from the designated overloaded state to a designated normal state and to resume transmission of the Diameter messages for the new Diameter sessions to the first destination queue of the first CDF based receiving the recovery message.

In some embodiments, the distributor unit is configured to determine that the offline charging system is experiencing an exigent condition impacting processing by the offline charging system of at least some of the Diameter messages received by the distributor unit from the CTF; and, to transmit an exigent-status message to the CTF for notifying the CTF of the exigent condition being experienced by the offline charging system.

In some embodiments, the distributor unit is configured to continue receiving and processing Diameter messages from the CTF for ongoing Diameter sessions during at least a portion of the duration of the exigent condition; and, to reject Diameter messages from the CTF for new Diameter sessions during at least some portion of the duration of the exigent condition.

In some embodiments, the distributor unit is configured to determine that the offline charging system has recovered from the exigent condition; and, to transmit an exigent-recovery message to the CTF for notifying the CTF of the recovery of the offline charging system from the exigent condition.

### BRIEF DESCRIPTION OF THE DRAWINGS

FIG. 1 illustrates an example embodiment of an offline charging architecture.

FIG. 2 illustrates is a tabular example of information used for distributing Diameter charging requests or messages.

FIG. 3 illustrates an example of a Diameter request distribution process in accordance with various aspects of the disclosure.

FIG. 4 illustrates a further tabular example of information used for distributing Diameter charging requests or messages.

FIG. 5 illustrates an example of exigent event process in accordance with various aspects of the disclosure.

FIG. 6 illustrates a block-diagram example of an apparatus for implementing various aspects of the disclosure.

### DETAILED DESCRIPTION

Various aspects of the disclosure are described below with reference to the accompanying drawings, in which like numbers refer to like elements throughout the description of the figures. The description and drawings merely illustrate the principles of the disclosure. It will be appreciated that those skilled in the art will be able to devise various arrangements that, although not explicitly described or shown herein, embody the principles and are included within spirit and scope of the disclosure.

As used herein, the term, “or” refers to a non-exclusive or, unless otherwise indicated (e.g., “or else” or “or in the alternative”). Furthermore, as used herein, words used to describe a relationship between elements should be broadly construed to include a direct relationship or the presence of intervening elements unless otherwise indicated. For example, when an element is referred to as being “connected” or “coupled” to another element, the element may be directly connected or coupled to the other element or intervening elements may be present. In contrast, when an element is referred to as being “directly connected” or “directly coupled” to another element, there are no intervening elements present. Similarly, words such as “between”, “adjacent”, and the like should be interpreted in a like fashion.

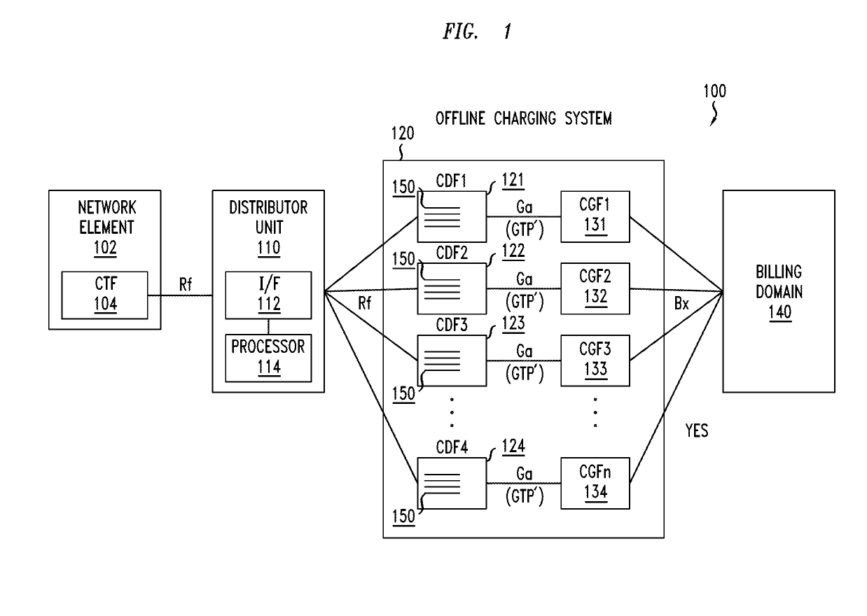

FIG. 1 illustrates an offline charging architecture 100 in an exemplary embodiment. Architecture 100 may be implemented in a circuit-switched network or a packet-switched network that provides services to its subscribers (i.e., end user and associated User Equipment (UE)) to provide offline charging for the subscribers. Some exemplary networks include IP Multimedia Subsystem (IMS) networks, Long Term Evolution (LTE) networks, General Packet Radio Service (GPRS), etc.

Architecture 100 includes a network element 102 that connects to an offline charging system (OFCS) 120 through a distributor unit 110. A network element 102 is an apparatus or equipment used in the provision of services provided by a network. For example, a network element may comprise a Serving-Call Session Control Function (S-CSCF) or application server (AS) of an IMS network, a Serving Gateway (SGW) or a Packet Data Network Gateway (PGW) of an LTE network, etc. Network element 102 includes a Charging Trigger Function (CTF) 104 that detects chargeable events for services provided by network element 102, assembles information for the chargeable events into matching charging events, and sends the charging events to a Charging Data Function (CDF). In the case of network element 102, CTF 104 uses a Diameter Rf interface. Therefore, CTF 104 assembles the charging information into accounting requests, such as a Diameter Rf Accounting Request (ACR). Although one CTF 104 is illustrated in FIG. 1, there may be many CTFs in contact with distributor unit 110. Although not specifically illustrated in FIG. 1, network element 102 may include a controller (e.g., a suitably programmed processor) or other hardware component to implement CTF 104.

OFCS 120 is an apparatus, a server, a device, or equipment configured to implement offline charging for sessions or services provided by a network. Offline charging can be of two types: session-based or event-based. In event-based charging, the CTF reports the usage or the service rendered where the service offering is rendered in a single operation, such as subscriber registration, re-registration, de-registration, etc. The CTF reports the usage in an ACR EVENT. Session-based charging is the process of reporting usage reports for a session, and uses the START, INTERIM, and STOP accounting data. During a session, CTF may transmit multiple ACR INTERIMs depending on the proceeding of the session.

In this embodiment, OFCS 120 includes a plurality of CDFs (CDF1-CDFn) 121-124. A CDF comprises an element or module within OFCS 120 that receives charging events from CTFs within network elements, formats the charging events into CDRs, and sends the CDRs to a CGF. OFCS 120 also includes a plurality of CGFs (CGF1-CGFn) 141-144. A CGF comprises an element or module within OFCS 120 that correlates CDRs for a session, and forwards a CDR file with the correlated CDRs to a billing domain 140. Billing domain 140 is the part of the operator network that receives and processes CDR files for billing mediation and other billing applications (e.g., statistical applications). CDFs in OFCS 120 communicate with CGFs over a Diameter Ga interface. In the case shown in FIG. 1, GTP′ is used on the Ga interface to transport CDRs from the CDFs to the CGFs. While a 1:1 relationship is shown between CDFs and CGFs in FIG. 1, an N:1 relationship is also possible. Although not specifically illustrated in FIG. 1, OFCS 120 may include one or more processors or other hardware components that implement CDFs 121-124 and CGFs 131-134.

Distributor unit 110 is implemented between CTFs (e.g., CTF 104) and the CDFs 121-124 in OFCS 120. The purpose of distributor unit 110 is to distribute Diameter requests or accounting requests (e.g., ACRs) from CTFs to the multiple CDFs 121-124 within OFCS 120 via queues 150. In this embodiment, distributor unit 110 includes an interface (I/F) 112 and a processor (PROC′R) 114. Interface 112 comprises a component (e.g., hardware, software, or a combination of hardware and software) for communicating via Diameter Rf protocol or another type of protocol. Processor 114 comprises a component (i.e., hardware) that performs logic to distribute Diameter requests to respective queues 150 associated the CDFs 121-124. Although distributor unit 110 is illustrated as being outside of OFCS 120, distributor unit 110 may be implemented on the same platform as OFCS 120.

Where OFCS 120 is implemented using a blade system architecture, for example, any or all of the distributor unit 110, CDFs 121-124, and CGFs 131-134 may be implemented to execute on respective blades (or servers) of a server chassis, where each blade includes physical computing resources such as a processor, memory, input/output devices, or other components typically found in computing devices. The queues 150 may be implemented on the blades to provide a queue message communication interface between, for example, the distributor unit 110 executing on one of the blades of the server chassis and the CDFs executing on other respective blades of the server chassis.

The task of distributing Diameter requests may include considering the weights, current load index, and other parameters of CDFs 121-124 to select a destination CDF instance for handling ACRs for a particular session. Distributor unit 110 may follow a round-robin strategy in selecting a queue 150 associated with a selected destination CDF for a particular session. Distributor unit 110 may work as a Back to Back User Agent (B2BUA), where Diameter sessions associated with a particular CTF are terminated on distributor unit 110, and equivalent and corresponding Diameter sessions are started between distributor unit 110 and the selected destination CDF via a selected queue 150. Each CTF would have established a Diameter connection with distributor unit 110, and send a Diameter ACR to distributor unit 110 that includes a Diameter “SessionId”. The Diameter “SessionId” is unique for the CTF for each session it reports.

The distributor unit 110 is configured to use a distribution algorithm to distribute ACRs associated with particular ACR Sessions to particular CDFs via queues 150. A distribution algorithm comprises any set of rules for determining a destination CDF (and queue) for ACRs for particular sessions. In one embodiment, distributor unit 110 may use a “consistent hashing” algorithm to select a destination CDF (and queue) for a particular Diameter session. The consistent hashing algorithm may use “SessionId” information included in the ACRs (e.g., Diameter requests) to select the destination CDF and queue for a given Diameter request. For example, with n CDFs present each providing an m number of interface queues 150, such as in FIG. 1, the consistent hashing algorithm may generate M numbers for a given Diameter “SessionId”, where M may be n times m. The destination CDF and queue associated with the highest of the numbers may be chosen for processing CDRs of the Diameter session.

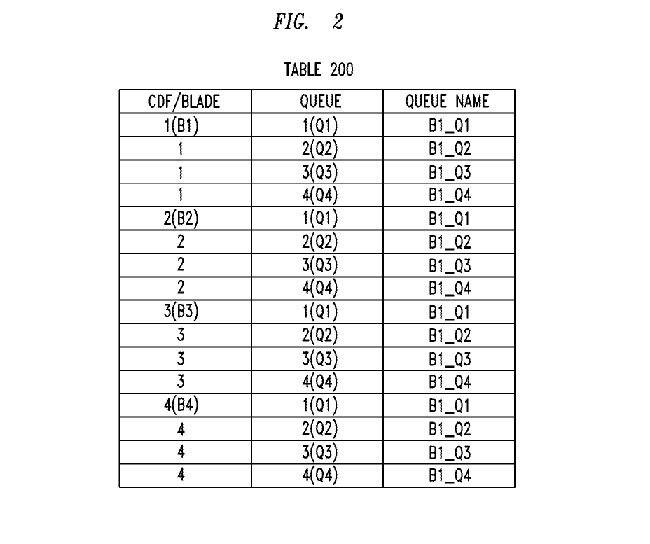

A tabular example of information that may be used to distribute ACR sessions in accordance with various aspects of the disclosure is illustrated in Table 200 of FIG. 2. The distributor unit 110 may store the information illustrated in table 200 in a data structure in memory and select a destination CDF and queue for particular SessionId's indicated in particular ACRs. Table 200 is an example illustration for four CDFs, each of which implements four queues (see FIG. 1) that are assigned unique names as shown in Table 200.

More particularly, distributor unit 110 may first statically determine a hashed value for each of the queues of the CDFs based on the queue names assigned to each queue. Since each queue (and each CDF) may be assigned a unique name or identity as shown in table 200 of FIG. 2, selecting a particular queue for particular ACR SessionIds may be understood as selecting both the destination CDF and the destination queue for particular ACR sessions. Thus, the distributor unit 110 may statically determined hashed values for each CDF/queue combination as:

Hs(1 . . . M)=F(CDF1 . . . n/Queue_1 . . . m)=F(UniqueQueueName)

For table 200, for e.g., the M number of hashed values may be determined as Hs(1)=F(b1_q1), Hs(2)=F(b1_q2), and Hs(3)=F(b1_q3), Hs(4)=F(b1_q4), Hs(5)=F(b2_q1), Hs(6)=F(b2_q2), and Hs(7)=F(b2_q3), Hs(8)=F(b2_q4), and so on for each of the remaining queues 150 of the CDFs.

Then, distributor unit 110 may also dynamically determine a hashed value for each Diameter “SessionId” (DSID):

Hi=F(DiameterSessionID).

The combination of the two values above may be used in computing the hash for each set of (DSID, CDFName/Qname) combinations:

Hc=F(Hs, Hi)

Distributor unit 110 may then select a particular destination queue (and thus also a particular destination CDF) that is determined to have the highest Hc value for handling the ACRs associated with particular Diameter “SessionIds”.

Selecting a particular destination queue of a particular CDF for an ACR based on a distribution algorithm as described above may be acceptable each time a Diameter request is received for a session. However, executing the distribution algorithm can be processor-intensive, and using the distribution algorithm each time a Diameter request is received can consume additional resources of the distributor unit. Also, selecting a destination queue for a Diameter session based on a distribution algorithm may be acceptable when the CDFs on an OFCS are operating correctly. However, it is often the case that one or more CDFs may be overloaded (or even out of service) for a time period. For example, if the CDFs are implemented and executed on particular blade servers as illustrated in Table 200 of FIG. 2, then one or more CDFs may be overloaded (or out of service) if there are problems with one or more of the blades. To illustrate the problem, a conventional distribution mechanism will use an algorithm to select a primary CDF for a Diameter session in response to receiving an initial ACR. If the primary CDF then becomes overloaded or goes out of service, then the conventional distribution mechanism will select an alternate CDF for subsequent ACRs (e.g., INTERIM). If the primary CDF happens to recover while the Diameter session is still active, then the conventional distribution mechanism will again use the algorithm to select the primary CDF for the Diameter session for subsequent ACRs. This scenario is a problem and undesirable, as the primary CDF will receive some ACRs for the Diameter session, while the secondary CDF receives other ACRs for the session. This will cause ‘incomplete CDR’ generation on the primary CDF for the first part of the session, incomplete CDR generation on the secondary CDF for the second part of the session, and incomplete CDR generation again on the primary CDF for the last part of the session. This increases the complexity for the downstream billing mediation system to combine the multiple incomplete CDRs into a coherent and complete CDR for the session, which is undesirable.

In the following embodiments, an example process or method is described that can reduce the occurrence of incomplete CDRs when a CDF that is selected as the “destination CDF” for a Diameter session is overloaded. As an overview of one exemplary embodiment, when the distributor unit 110 receives a Diameter request for a Diameter session from a CTF, for example, the distributor unit 110 is able to process the Diameter request to identify that the selected destination CDF for the Diameter session is overloaded, and take appropriate action with respect to particular queues of the overloaded destination CDF such that the overloaded destination CDF continues to receive Diameter requests or ACRs for ongoing sessions via particular destination queues of the overloaded destination CDF, while Diameter requests for new Diameter sessions designated for an overloaded CDF are throttled to prevent some or all of the Diameter requests for the new Diameter sessions from being transmitted to particular queues of the overloaded CDF in order to alleviate further overloading of the already overloaded CDF.

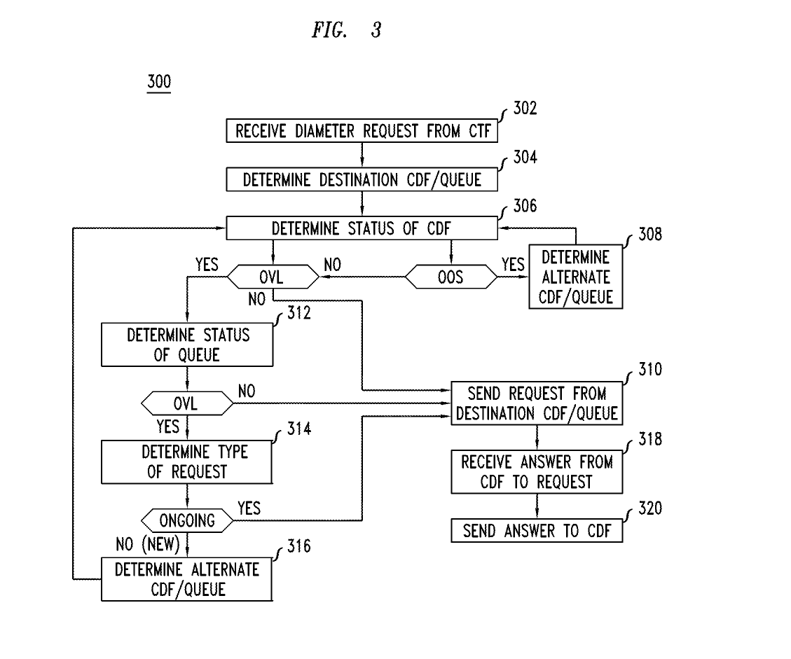

FIG. 3 is a flow chart illustrating a process or method 300 for distributing Diameter requests to destination CDFs in accordance with various aspects of the disclosure. The steps of process 300 will be described with reference to distributor unit 110 in FIG. 1, but those skilled in the art will appreciate that process 300 may be performed in other systems. Furthermore, while particular steps are described in a particular order in FIG. 3 for enabling the reader to more easily understand the various aspects and principles of the disclosure, it will be readily apparent from the description below that in other embodiments certain steps of process 300 may be modified and performed in a single step, in a different order, or omitted, as will be understood by those skilled in the art.

To begin, it is assumed that CTF 104 detects a chargeable event for a service provided by network element 102 (see FIG. 1). The CTF 104 assembles information for the chargeable event into a Diameter Rf ACR (e.g., Diameter request) for a Diameter session. The type of accounting for the service is further assumed to be session-based, so CTF 104 may insert a “START” value in the Accounting-Record-Type AVP of the ACR for new sessions, and insert an “INTERIM” or a “STOP” value in the Accounting-Record-Type AVP of the ACR for ongoing sessions. CTF 104 then sends the ACR (i.e., Diameter Rf Accounting Request or Diameter request) to the distributor unit 110.

In response to receiving the ACR from the CTF 104 (step 302), distributor unit 110 selects a destination CDF for receiving and processing the ACR via a selected destination queue 150 of the selected destination CDF (step 304). The distributor unit 110 may select the destination CDF and queue in several ways. For example, and as described above, in one embodiment the distribution unit 110 selects a particular destination queue (and thus also a particular destination CDF) for particular ACR sessions using a consistent hashing distribution algorithm.

Alternatively, or in addition, in some embodiments the distribution unit 110 selects a destination queue and a destination CDF based on queue/CDF information indicated in the ACR received from the CTF 104. Including information identifying a particular destination queue of a particular destination CDF in the ACR itself may be advantageous as it may remove the need for the distribution unit 110 to employ the distribution algorithm (described above) for each ACR received by the distributor unit 110 from the CTF 104. Various embodiments and methods, in the context of system 100 of FIG. 1, for enabling the CTF 104 to include an override parameter in the ACR that indicates a destination CDF (and/or queue) for particular ACR sessions to the distributor unit 110 are described in the commonly owned and co-pending U.S. application Ser. No. 14/259,949 (“949 application”), filed on Apr. 23, 2014, which is incorporated by reference herein in its entirety.

Upon selection of the destination CDF, the distributor unit 110 determines the status of the selected destination CDF (step 306). In one embodiment, the status of the selected destination CDF may be determined as being out-of-service (OOS), overloaded (OVL), or normal. The status of the destination CDF may be determined in several ways. In one embodiment, for example, the distributor unit 110 may query the status of the destination CDF via a request transmitted from the distributor unit 110 to the selected destination CDF. Alternatively, the status of the destination CDF may be indicated by the destination CDF to the distributor unit 110 (e.g., periodically or synchronously), and the latest determined status may be used as the current status of the selected destination CDF.

In some embodiments, for example, a destination CDF may be determined to be OOS if no response is received (e.g., within a predetermined period of time) by the distributor unit 110 from the destination CDF in response to a status query. In some embodiments, a determination that the destination CDF is OOS may also be made if a periodic status is not received from the destination CDF, or if an message is received from the destination CDF indicating that it is experiencing conditions that render (or are expected to imminently render) it OOS and unable to process ACRs. In yet other embodiments, a destination CDF may indicate itself as OOS to the distributor unit if resource consumption of the blade (e.g., server) on which the destination CDF is executing exceeds certain critical thresholds (e.g., CPU, bandwidth, or memory usage).

If a determination is made that the destination CDF is OOS, the distributor unit selects an alternate destination CDF/queue (step 308) for processing the ACR received from the CTF 104. The selection of the alternate CDF/queue may be performed based on a distribution algorithm, such as a distribution algorithm described above. For example, the distributor unit 110 may select an alternate destination CDF/queue associated with the next highest hashed number. The distributor unit 110 may then return to step 306 to determine the status of the selected alternate destination CDF.

If a determination is made in step 306 that a selected destination CDF is not OOS, then the distributor unit 110 may determine if the selected destination CDF is overloaded or OVL (as opposed to OOS). The determination that the selected destination CDF is overloaded (but not OOS) may be also be made in various ways. In one embodiment, for example, the distributor unit 110 may query the status of the destination CDF via a status request transmitted from the distributor unit 110 to the selected destination CDF. Alternatively, the status of the destination CDF may also be indicated by the destination CDF to the distributor unit 110 (e.g., periodically or synchronously), and the latest received status indicating an overload may be used as the current status of the selected destination CDF.

In some embodiments, a determination that the destination CDF is overloaded may also be made if a periodic status message from the destination CDF indicates it is overloaded (e.g., processing a back-log of a large or relatively large number of ACRs), or if a status message is received from the destination CDF indicating that it is experiencing conditions that render it overloaded, for e.g., physical resource (e.g., CPU or memory) consumption for processing ACRs on the blade (e.g., server) on which the destination CDF is executing is above a desired or optimum physical resource usage threshold, resulting in a processing backlog due to increased (or slower) processing times for ACRs. In some embodiments, an absence of a periodic status message may also be treated as a manifestation of an overload condition for a given CDF.

If a determination is made that the selected destination CDF is neither OOS nor OVL (e.g., a status message received from the selected CDF indicates a normal status or in the absence of any other indications of an OOS or overloaded condition as described above), the distributor unit 110 may determine that the selected destination CDF is operating normally. In this case, the distributor unit 110 may then transmit or distribute the ACR received from CTF 104 to the selected destination CDF (e.g. CDF1) for further processing by transmitting the ACR to the selected queue of the destination CDF (step 310).

If a determination is made that the selected destination CDF is not OOS but that the selected destination CDF is overloaded, the distributor unit 110 may determine a designated status of the selected destination queue of the overloaded CDF (step 312). In one embodiment, for example, the designated status of the selected destination queue may be determined as being “queue-normal” or “queue-overloaded”. Aspects related to designating a status for one or more queues 150 of a CDF are discussed further below.

If a determination is made in step 312 that the designated status of the selected destination queue is not “queue-overloaded” (or is “queue-normal”), then the distributor unit 110 transmits or distributes the ACR received from CTF 104 to the selected destination CDF (e.g. CDF1) for further processing by transmitting the ACR to the selected queue of the destination CDF (step 310), even though selected destination CDF is determined to be overloaded.

If a determination is made in step 312 that the designated status of the destination queue of the destination CDF is “queue-overloaded”, then the distributor unit 110 determines whether the ACR received from the CTF 104 is for a new session or an ongoing session based on data included in one or more fields of the ACR (step 314). For example, the distributor unit 110 may determine that the ACR is for a new session if the ACR includes a “START” value in the Accounting-Record-Type AVP of the ACR. Alternatively, the distributor unit 110 may determine that the ACR is for an ongoing session if the ACR includes an “INTERIM” or a “STOP” value in the Accounting-Record-Type AVP of the ACR for ongoing sessions.

If a determination is made that the ACR is for an ongoing session, then the distributor unit 110 transmits or distributes the ACR received from CTF 104 to the selected destination CDF (e.g. CDF1) for further processing by transmitting the ACR to the selected queue of the destination CDF (step 310) even though the selected destination CDF is determined to be overloaded, in order to avoid an occurrence of an incomplete CDR.

If a determination is made that the ACR is for a new session, then the distributor unit 110 does not transmit the ACR for the new session to the selected destination CDF that is overloaded because the designated status of the selected queue is “queue-overloaded”. Instead, the distributor unit selects an alternate destination CDF/queue (step 316) for processing the ACR received from the CTF 104. The selection of the alternate CDF/queue may be performed based on a distribution algorithm, such as a distribution algorithm described above. For example, the distributor unit 110 may select the next highest hashed number determined based on a round-robin distribution algorithm and select a destination CDF/queue associated with the next highest hashed number. The distributor unit 110 may then return to step 306 to determine the status of the selected alternate destination CDF.

In step 318, the distributor unit 110 receives a response from the selected destination CDF to the ACR transmitted by the distributor unit 110. For example, the selected destination CDF (e.g., CDF1) may process the ACR or Diameter request normally, which may include generating a Charging Data Record (CDR). The selected destination CDF may also generate a Diameter answer (e.g., Accounting Answer (ACA)) as a response to the ACR received from the distributor unit 110 and send the Diameter answer to distributor unit 110. The distributor unit 110 receives the Diameter answer from selected destination CDF and sends the Diameter answer to CTF 104 (step 320).

As noted previously, the process 300 described above may reduce the occurrence of incomplete CDRs when the selected destination CDF is in an overloaded (but not OOS) state. The process achieves this by continuing to send ACRs for ongoing sessions to certain queues of the overloaded CDF, while preventing (or throttling) new ACR sessions to be transmitted to certain queues of the overloaded CDF based on the designated status of the queues. Continuing to transmit ACRs for ongoing sessions to certain designated queues of the overloaded destination CDF reduces the occurrence of incomplete CDRs for those ongoing sessions. At the same time, preventing transmission of at least some ACRs for new sessions to the overloaded destination CDF allows time and resources for recovery of the destination CDF to a normal operating status.

Aspects related to designating the status of one or more queues 150 of a CDF are described now. As described previously, an overloaded CDF (e.g., a selected destination CDF) may indicate to the distributor unit 110 that it is experiencing operating conditions that render it overloaded, for e.g., when a physical resource (e.g., CPU, memory, network condition, etc.) consumption for processing ACRs on a blade (e.g., server) on which the CDF is executing exceeds a desired or optimum physical resource usage threshold or due to increased (or slower) processing times for ACRs. An overloaded CDF may also designate a status of “queue-overloaded” to one or more queues 150 of the overloaded CDF. In one embodiment, for example, the overloaded CDF may designate a “queue-overloaded” status to each of the queues 150 of the overloaded CDF (as opposed to a “queue-normal” status, which may be the default designation), while in other embodiments the overloaded CDF may designate a “queue-overloaded” status to some of the queues 150 of the overloaded CDF while maintaining a designation of “queue-normal” status for one or more other (e.g., remaining) queues of the overloaded CDF.

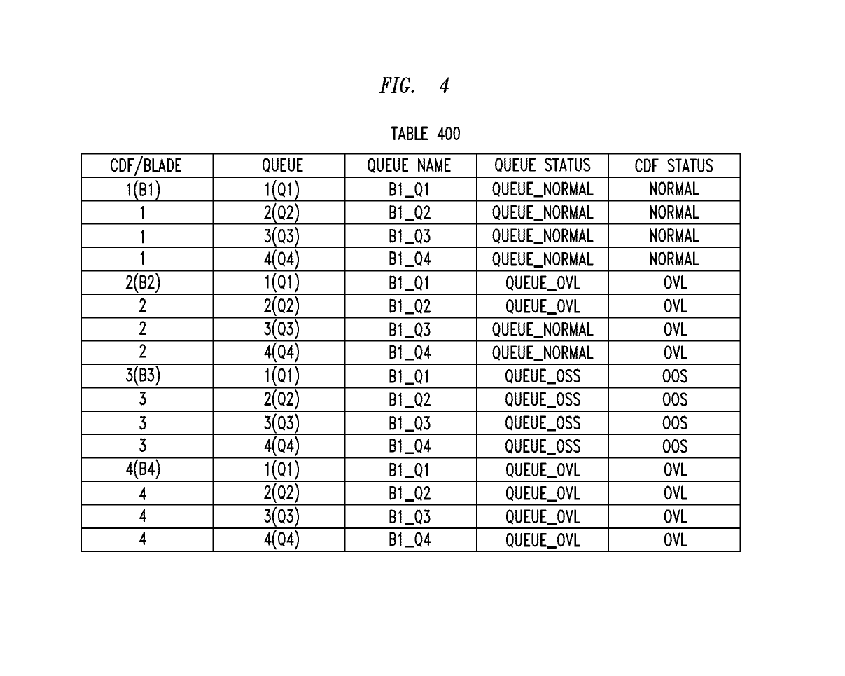

The designation of the status of one or more queues 150 of the overloaded CDF may be sent to the distributor unit 110 (e.g., in response to a status inquiry from the distributor unit 110 for one or more queues of the CDF or otherwise (e.g., periodically or based on the operating conditions of the CDF). The status of the CDFs and the designated status of one or more queues of the CDFs may be maintained in memory accessible to the distributor unit 110 for use in process 300 of FIG. 3. FIG. 4 illustrates an example of a table 400 that depicts status information for the CDFs 121-124 and the queues 150 that may be maintained by the distributor unit 110.

It will be apparent to one skilled in the art that many modifications can be made to the illustrative embodiments described above. In some embodiments, the status information for one or more queues or one or more CDFs may be used in step 304 to initially determine a destination CDF and queue for particular types of ACR sessions. For example, upon receiving an ACR from the CTF 104 (step 302), the distributor unit 110 may determine whether the ACR is for a new Diameter session or an ongoing Diameter session. If the ACR is for a new Diameter session, the distributor unit 110 may (based on information illustrated in table 400), exclude from the distribution algorithm all queues for CDFs that are determined to be OOS, and all queues having a “queue-overloaded” status for CDFs determined to be overloaded. Alternatively, if the ACR is for a ongoing Diameter session, the distributor unit 110 may (based on information illustrated in table 400), exclude from the distribution algorithm all queues for CDFs that are determined to be OOS only.

In some embodiments, the determination that a CDF is in an overloaded condition may be made in step 306 based on determining that a designated status of one or more queues 150 of the CDF is a “queue-overloaded” status. Similarly, in some embodiments, a determination may be made that a CDF is in an OOS condition if a designated status of one or more queues 150 is determined to be “queue-OOS” (e.g., based on receiving such designation from a CDF at the distributor unit 110). A CDF may also be determined to have a normal status if none of the queues of the CDF are determined to be in a designated “queue-overloaded” or “queue-OOS” status (or all queues 150 are determined to be in a designated “queue-normal” status).

In some embodiments, the designation of the status of one or more queues of a CDF may be made independently at the distributor unit 110. For example, the distributor unit 110 may receive an indication from a CDF in step 306 that it is experiencing overload conditions. The CDF may also provide an indication of the degree of overload (e.g., resource usage percent or value). In such a case, the distributor unit 110 may update table 400 of FIG. 4, maintained in memory, to designate one or more queues 150 of the CDF to be a “queue-overloaded” status from a “queue-normal” status. The number of queues that are designated by the distributor unit 110 to be in the “queue-overloaded” status may be based on the degree of overloading being experienced by the CDF. Similarly, the distributor unit 110 may independently designate a status of “queue-OOS” for all queues 150 of a CDF if a determination is made that the CDF is OOS (e.g., in the absence of a response to a status query to the CDF from the distributor unit).

In all embodiments, the distributor unit 110 may be configured to continue to send ACRs for ongoing sessions to certain designated queues of an overloaded CDF to prevent or reduce incomplete CDRs, while also eliminating (or at least reducing) transmission of ACRs for new sessions to certain designated queues of the overloaded CDF.

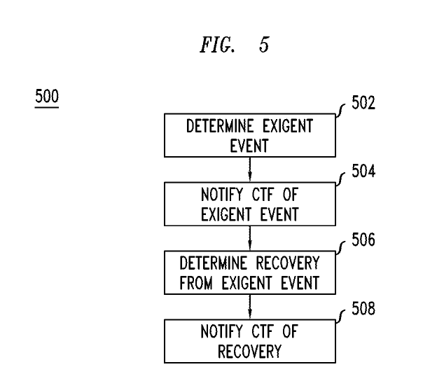

Additional aspects with respect to processing exigent circumstances that may occasionally arise with respect to the offline charging system 120 of FIG. 1 are now described in conjunction with process 500 of FIG. 5. The steps depicted in process 500 are described as implemented by the distributor unit 110 of FIG. 1, but it is to be understood that in some embodiments the process 500 may be implemented in other systems.

In step 502, the distributor unit 110 determines an occurrence of an exigent event for the offline charging system 120. In one embodiment, for example, the distributor unit 110 may determine (e.g., based on information maintained in memory and illustrated in table 400 of FIG. 4) that all CDFs (or, for that matter, CGFs) of the offline charging system 120 are in an OOS state. In another embodiment, the distributor unit 110 may determine that all CDFs (or CGFs) of the offline charging system 120 are in an OVL state. Exigent events where all (or substantial number) of the CDFs are either in an OOS state or OVL state may occur occasionally, such as, for example, when all (or a substantial number) of the blades in a server chassis experience serious operating conditions (e.g., overheating, power outage) or other events that have a substantial detrimental effect on the operation of the offline charging system 120 in general.

Upon determining the occurrence of an exigent event, the distributor unit 110 notifies the CTF 104 that the offline charging system 120 is experiencing a particular exigent event (step 504). Where the exigent event is one where all (or a substantial number) of CDFs are OOS, the distributor unit 110 may notify the CTF 104 that the offline charging system is unable to process any ACRs (whether for new sessions or for ongoing sessions) by transmitting a message to the CTF 104. In some embodiments, for example, the distributor unit 110 may transmit a 3GPP DIAMETER_TOO_BUSY 3004 message to the CTF 104 to indicate that the offline charging system is unable to accommodate any ACR requests or messages from the CTF. In some embodiments, the distributor unit 110 may also send a Diameter DISCONNECT PEER REQUEST (DPR) message to the CTF 104 to request removal of all connections between the CTF 104 and the offline charging system 120. In the event that the CTF 104 continues to transmit requests to the distributor unit 110 to establish a connection with the offline charging system 120 via a Diameter CER message, the distributor unit 110 may reject the connections requested by the CTF. Upon receiving one or more of the messages indicating an exigent condition as described in the examples above, the CTF 104 may transmit the ACRs to an alternative offline charging system for processing, though such action may (or likely) result in occurrence of incomplete CDRs for ongoing sessions that were previously being handled by one or more of the now OOS CDFs.

Where the exigent event is one where all (or a substantial number) of CDFs are OVL (not OOS), the distributor unit 110 may notify the CTF 104 that the offline charging system is able to process ACRs for ongoing sessions but not ACRs for new sessions. In some embodiments, for example, the distributor unit 110 may transmit a proposed new message as yet not supported by 3GPP standards (e.g., a DIAMETER message having a new return code of 3099 indicating a “DIAMETER_SERVER_OVERLOAD” condition) to the CTF 104 to indicate that the offline charging system is able to receive and process ACRs for ongoing sessions but not ACRs for new sessions. In practice, this return code (e.g., 3099) may be transmitted by the distributor unit 110 to the CTF 104 only when session START (ACR START requests) or non-session related event requests are received from the CTF. ACR messages that are received from the CTF 104 for ongoing sessions (e.g., ACR INTERIM or ACR STOP requests) may continue to be received and processed by the offline charging system 104 as described in various aspects above in the overloaded exigent conditions. When the CTF 104 receives the new DIAMETER_SERVER_OVERLOAD message having a return code of 3099, the CTF 104 may be configured to send the ACRs for new sessions and non-session related event messages to an alternate offline charging system, while continuing to send ACRs for currently ongoing sessions to the distributor unit 110 for processing by the offline charging system 120. As the CTF 104 may continue to send ACRs for ongoing sessions to the distributor unit 110 of the offline charging system 120, the occurrence of incomplete CDRs may be reduced or avoided. At the same time, as the CTF 104 may not send ACRs for new sessions or event messages to the offline charging system 120, the operating load of the offline charging system 120 may be prevented from increasing further which may allow the offline charging system 120 to eventually recover from the overloaded conditions as described above.

In step 506, the distributor unit 110 may determine that the offline charging system 120 has recovered from an exigent event. For example, the distributor unit 110 may determine that all (or a substantial number) of the CDFs are back in a normal state as opposed to a previous OOS or OVL state.

In step 508, the distributor unit 110 may notify the CTF 104 that the offline charging system 120 has recovered from the exigent event and is ready to process ACRs normally. For example, the distributor unit 110 may determine that all (or a substantial number) of the CDFs are back in a normal state as opposed to a previous OOS or OVL state and transmit a system normal message to the CTF. In practice, the distributor unit 110 may send several types of messages that the CTF is configured to recognize as a system normal message from the offline charging system 120.

It is assumed that in the recovery the offline charging system 120 stabilizes after a while and the loads on the blades (or CDFs) return to partial or full normalcy and the offline charging system as a whole is again able to assume further load in terms of ACR or event messages from the CTF. In this case, most if not all queues of the CDFs should be determined to be in a ‘queue-normal’ status by the distributor unit 110, or most of the queues may be determined to be in a “queue-normal” state though some queues may be determined to be in a ‘queue-overloaded’ state. However, a determination may be made that the overall health of the offline charging system 120 is such that the offline charging system 120 is able to handle additional load.

In such a case, in some embodiments the distributor unit 110 may transmit a proposed new (and currently unsupported by 3GPP/IETF standards) Diameter message ARR (Accounting Resumption Request) having, for example, a return code of 290, to the NE/CTF to indicate recovery from an exigent event. The CTF (or NE) may be configured to process the ARR message as a declaration of resumption of normal state from the offline charging system 120 to start receiving ACRs (for new sessions and for ongoing sessions) and event messages. The CTF 104 may acknowledge the ARR message with a proposed new(and currently unsupported by 3GPP/IETF standards) Diameter ARA (Accounting Resumption Answer) message having, for example, a return code of 291, to the distributor unit 110.

In some embodiments, the distributor unit 110 may transmit a gratuitous 3GPP Diameter Capability-Exchange Request (CER) message to the CTF 104 (or NE 102) to commence session establishment to indicate recovery from an exigent event. Note that the in accordance with conventional 3GPP, CERs are normally initiated or transmitted by the CTF 104 (or NE 102). When initiated from the distributor unit 110 and received by the CTF 104, the CTF 104 may be configured to process the received gratuitous CER message from the distributor unit 110 as a declaration of resumption of normal state to start receiving accounting messages. The CTF 104 may acknowledge the CER message with a 3GPP Capabilities-Exchange Acknowledgement (CEA) message.

In some embodiments, the distributor unit 110 may transmit a gratuitous 3GPP Accounting-Answer message (ACA) with a new return code of 1099 (DIAMETER_SERVER_NORMAL_LOAD) (return code 1099 and gratuitous ACA's are not currently unsupported in 3GPP) to the CTF 104 (or NE 102) to indicate recovery from an exigent event. The CTF 104 may be configured to process the received the gratuitous ACA message from the distributor unit 110 as a declaration of resumption of normal state to start receiving accounting messages. The CTF 104 may be configured to acknowledge the gratuitous ACA message with its own 3GPP ACA message.

Finally, in some embodiments the distributor unit 110 may use a “piggyback” mechanism to indicate the normal status of the offline charging system 120 to the CTF 104. For example, the distributor unit may piggyback or include an additional new success code in an ACA to indicate normalcy of the offline charging system 110.

It will be apparent from the foreign that the process 500 described in FIG. 5 requires changing the operation of the CTF 104 (or NE 102) support new functionality not contemplated under the current 3GPP standards. However, it is believed that as described above the foregoing aspects provide a number of advantages, such as reduction in occurrence of incomplete CDRs and a more robust failure-recovery process in the offline charging system 120, as well as between the offline charging system 120 and the NE/CTF.

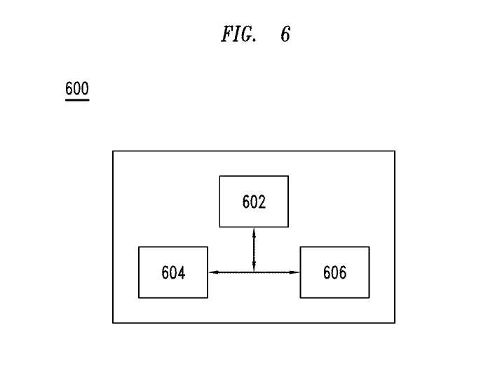

FIG. 6 depicts a high-level block diagram of a computing apparatus 600 suitable for implementing various aspects of the disclosure (e.g., one or more steps of process 300). Although illustrated in a single block, in other embodiments the apparatus 600 may also be implemented using parallel and distributed architectures. Thus, for example, various steps such as those illustrated in the example of process 300 or 500 may be executed using apparatus 600 sequentially, in parallel, or in a different order based on particular implementations. Apparatus 600 includes a processor 602 (e.g., a central processing unit (“CPU”)), that is communicatively interconnected with various input/output devices 604 and a memory 606. Apparatus 600 may be implemented as one or more blades in a blade chassis.

The processor 602 may be any type of processor such as a general purpose central processing unit (“CPU”) or a dedicated microprocessor such as an embedded microcontroller or a digital signal processor (“DSP”). The input/output devices 604 may be any peripheral device operating under the control of the processor 602 and configured to input data into or output data from the apparatus 600, such as, for example, network adapters, data ports, and various user interface devices such as a keyboard, a keypad, a mouse, or a display.

Memory 606 may be any type of memory suitable for storing electronic information, such as, for example, transitory random access memory (RAM) or non-transitory memory such as read only memory (ROM), hard disk drive memory, compact disk drive memory, optical memory, etc. The memory 606 may include data (e.g., information illustrated in tables 200 and 400,) and instructions which, upon execution by the processor 602, may configure or cause the apparatus 600 to perform or execute the functionality or aspects described hereinabove (e.g., one or more steps of process 300). In addition, apparatus 600 may also include other components typically found in computing systems, such as an operating system, queue managers, device drivers, or one or more network protocols that are stored in memory 606 and executed by the processor 602.

While a particular embodiment of apparatus 600 is illustrated in FIG. 6, various aspects of in accordance with the present disclosure may also be implemented using one or more application specific integrated circuits (ASICs), field programmable gate arrays (FPGAs), or any other combination of hardware or software. For example, data may be stored in various types of data structures (e.g., linked list) which may be accessed and manipulated by a programmable processor (e.g., CPU or FPGA) that is implemented using software, hardware, or combination thereof.

Although aspects herein have been described with reference to particular embodiments, it is to be understood that these embodiments are merely illustrative of the principles and applications of the present disclosure. It is therefore to be understood that numerous modifications can be made to the illustrative embodiments and that other arrangements can be devised without departing from the spirit and scope of the disclosure.

1. An apparatus comprising:
a distributor unit configured to connect to a plurality of Charging Data Functions (CDFs) of an offline charging system;
the distributor unit comprising a processor configured to:
receive Diameter messages for one or more Diameter sessions from a Charging Trigger Function (CTF) associated with a Network Element (NE);
determine that a first destination queue of a first destination CDF that is selected for receiving the Diameter messages for the one or more Diameter sessions is designated in an overloaded state;
for the Diameter messages that are for ongoing Diameter sessions, the distributor unit is configured to continue to send the Diameter messages for the ongoing Diameter sessions to the first destination queue of the first destination CDF while the first destination queue is designated in the overloaded state, and,
for the Diameter messages that are for new Diameter sessions, the distributor unit is configured to not send the Diameter messages for the new Diameter sessions to the first destination queue of the first CDF while the first destination queue is designated in the overloaded state.

2. The apparatus of claim 1, wherein:
the distributor unit is further configured to send the Diameter messages for the new Diameter sessions to a second destination queue of the a second destination CDF based on the determination that the first destination queue of the first CDF is designated in the overloaded state.

3. The apparatus of claim 1, wherein:
the distributor unit is further configured to select the first destination queue of the first destination CDF and to select the second destination queue of the second destination CDF based on a parameter in the Diameter messages received from the CTF and a distribution algorithm.

4. The apparatus of claim 3, wherein:
the distribution algorithm comprises a consistent hashing algorithm for selecting the first destination queue or the second destination queue based on a session identifier in the Diameter messages.

5. The apparatus of claim 4, wherein:
the distributor unit is further configured to determine that a selected destination CDF for receiving Diameter messages for an ongoing Diameter session or a new Diameter session is out of service, to select an alternate destination CDF based on the distribution algorithm, to insert an override parameter in the Diameter messages with a CDF identifier identifying the alternate destination CDF, and to send the Diameter messages to the alternate destination CDF.

6. The apparatus of claim 1 wherein:
at least one of the Diameter messages received from the CTF comprises a Diameter Accounting Request (ACR).

7. The apparatus of claim 1, wherein:
the distributor unit is further configured to receive a recovery message from the first destination CDF indicating that the first destination queue has recovered from the overloaded state to a normal state; and,
the distributor unit is configured to resume sending the Diameter messages for the new Diameter sessions to the first destination queue of the first CDF based on the recovery message.

8. The apparatus of claim 1, wherein the distributor unit is further configured to:
determine that the offline charging system is experiencing an exigent condition impacting processing by the offline charging system of at least some of the Diameter messages received by the distributor unit from the CTF; and,
transmit an exigent-status message to the CTF for notifying the CTF of the exigent condition.

9. The apparatus of claim 8, wherein the distributor unit is further configured to:
continue to receive and process Diameter messages from the CTF for ongoing Diameter sessions during at least a portion of the duration of the exigent condition; and,
reject Diameter messages from the CTF for new Diameter sessions during at least some portion of the duration of the exigent condition.

10. The apparatus of claim 8, wherein the distributor unit is further configured to:
determine that the offline charging system has recovered from the exigent condition; and,
transmit an exigent-recovery message to the CTF for notifying the CTF of the recovery of the offline charging system from the exigent condition.

11. A method for processing messages in an offline charging system, the method comprising:
receiving, at a distributor unit connected to a plurality of Charging Data Functions (CDFs) of the offline charging system, Diameter messages for one or more Diameter sessions from a Charging Trigger Function (CTF) associated with a Network Element (NE);
determining that a first destination queue of a first destination CDF that is selected for receiving the Diameter messages for the one or more Diameter sessions is designated in an overloaded state;
for the Diameter messages that are for ongoing Diameter sessions, continuing to send the Diameter messages for the ongoing Diameter sessions to the first destination queue of the first destination CDF of the offline charging system while the first destination queue is designated in the overloaded state, and,
for the Diameter messages that are for new Diameter sessions, not sending the Diameter messages for the new Diameter sessions to the first destination queue of the first CDF while the first destination queue is designated in the overloaded state.

12. The method of claim 11, further comprising:
sending the Diameter messages for the new Diameter sessions to a second destination queue of the a second destination CDF of the offline charging system based on the determination that the first destination queue of the first CDF is designated in the overloaded state.

13. The method of claim 11, further comprising:
selecting the first destination queue of the first destination CDF and the second destination queue of the second destination CDF based on a parameter in the Diameter messages received from the CTF and a distribution algorithm.

14. The method of claim 13, wherein:
the distribution algorithm comprises a consistent hashing algorithm for selecting the first destination queue or the second destination queue based on a session identifier in the Diameter messages.

15. The method of claim 14, further comprising:
determining that a selected destination CDF for receiving Diameter messages for an ongoing Diameter session or a new Diameter session is out of service, selecting an alternate destination CDF based on the distribution algorithm, inserting an override parameter in the Diameter messages with a CDF identifier identifying the alternate destination CDF, and, sending the Diameter messages to the alternate destination CDF.

16. The method of claim 11, wherein:
receiving the Diameter messages for one or more Diameter sessions from the CTF further comprises receiving at least one Diameter Accounting Request (ACR).

17. The method of claim 11, further comprising:
receiving, at the distributor unit, a recovery message from the first destination CDF indicating that the first destination queue has recovered from the overloaded state to a normal state; and,
resuming transmission of the Diameter messages for the new Diameter sessions to the first destination queue of the first CDF based receiving the recovery message.

18. The method of claim 11, further comprising:
determining, at the distributor unit, that the offline charging system is experiencing an exigent condition impacting processing by the offline charging system of at least some of the Diameter messages received by the distributor unit from the CTF; and,
transmitting an exigent-status message to the CTF for notifying the CTF of the exigent condition being experienced by the offline charging system.

19. The method of claim 18, further comprising:
continuing to receive and process Diameter messages from the CTF for ongoing Diameter sessions during at least a portion of the duration of the exigent condition; and,
rejecting Diameter messages from the CTF for new Diameter sessions during at least some portion of the duration of the exigent condition.

20. The method of claim 18, further comprising:
determining that the offline charging system has recovered from the exigent condition; and,
transmitting an exigent-recovery message to the CTF for notifying the CTF of the recovery of the offline charging system from the exigent condition.
